(19) United States
(12) Patent Application Publication
(10) Pub. No.: US 2014/0360390 A1
(43) Pub. Date: Dec. 11, 2014

(54) METHOD FOR MANUFACTURING A SCREEN STRUCTURE AND SCREEN STRUCTURE FOR SCREEN PRINTING

(71) Applicant: GALLUS FERD. RUEESCH AG, ST. GALLEN (CH)

(72) Inventors: HANS-RUDOLF FRICK, HERISAU (CH); HEINZ BROCKER, HERISAU (CH); ROLAND GREUTMANN, SPEICHERSCHWENDI (CH)

(73) Assignee: GALLUS FERD. RUEESCH AG, St. Gallen (CH)

(21) Appl. No.: 14/294,262

(22) Filed: Jun. 3, 2014

(30) Foreign Application Priority Data
Jun. 6, 2013 (DE) 102013009462.3

(51) Int. Cl. B41C 1/14; B41N 1/24

(52) U.S. Cl. CPC B41C 1/14; B41N 1/247
USPC 101/128.21; 101/128.4

(57) ABSTRACT

A method for manufacturing a screen structure and a screen structure manufactured in accordance with the method include the provision of at least two mesh layers. A first mesh layer and a second mesh layer are provided and brought together to contact each other. Advantageously, the first and second mesh layers are jointly metal-plated. The applied metal firmly bonds the two mesh layers to each other to create a composite mesh. An advantage of the screen structure is that it has a particularly great ink application volume and a very high degree of stability.

### CROSS-REFERENCE TO RELATED APPLICATION

This application claims the priority, under 35 U.S.C. §119, of German Patent Application DE 10 2013 009 462.3, filed Jun. 6, 2013; the prior application is herewith incorporated by reference in its entirety.

### BACKGROUND OF THE INVENTION

### Field of the Invention

The invention relates to a method for manufacturing a screen structure having at least two mesh layers. The invention also relates to a screen structure, in particular for screen printing, including at least two mesh layers disposed substantially parallel to each other, in particular a screen structure manufactured in accordance with the methods of the invention.

Industrial applications for screens or fabrics are known from many fields. In applications in the field of filtering, a square mesh is the most usual configuration. That mesh configuration has been adopted by the printing industry. With the available photosensitive layers and the known application processes, a reasonable image resolution may only be achieved if a large number of “supports” is provided. Thus, high mesh-count mesh types are becoming more and more widely used.

For printed electronics, screens that are as thin as possible and meshes made of the thinnest possible wire are used to ensure that pastes may pass smoothly and to allow the creation of fine-lined images.

In the field of solar cell coating, a high application of paste and a precise, fine resolution is required, for example to apply PCB tracks as current lines without covering too much of the solar cells to ensure a high degree of efficiency of the solar cells.

The screens or types of mesh used to print electronics are very expensive and delicate to process, i.e. they are not suitable for the production of screen printing plates for rotary screen printing. Their inadequacy is also due to the fact that for a rotary screen, the screen meshes may only be tensioned in one direction, i.e. the direction of the longitudinal axis of the cylinder, whereas in flat-bed screen printing, they may be tensioned in two dimensions.

In rotary screen printing, the ink is transported through the screen due to the hydrodynamic pressure generated in front of the doctor blade by the rotation of the screen and the engagement of the doctor blade. For structural reasons, only open or semi-open blade systems may be used, causing the dynamic pressure to be influenced by many variables such as viscosity, fill level, and rotary speed. Simple ways of increasing the hydrodynamic pressure are increasing the rotary speed or the fill level. Such a screen printing unit is described in International Publication No. WO 99/19146A1, corresponding to U.S. Pat. No. 6,412,407, for instance.

In the prior art, the basic structure for screen materials is plain-weave stainless steel mesh. The ratio between screen opening, surface of contact, and mesh thickness has proved to be suitable. The thickness of the structure, i.e. the mesh thickness (initial dimension prior to calendaring), approximately corresponds to twice the wire thickness. In a further step, the basic structure is calendared to achieve the desired raw mesh thickness. That also achieves a higher degree of smoothness of the screen and thus a lower degree of wear to the screen and to the doctor blade. In the subsequent nickel-plating process, the mesh is reinforced to make it more resistant to wear and the points of support in the region of the intersections are enlarged. A process for creating such screen materials is described, for example, in European Patent Application EP 0 182 195 A2, corresponding to U.S. Pat. No. 4,705,608.

It is also known to use non-woven metal webs, synthetic mesh, perforated metal plates, metal films, and combinations thereof as alternatives.

In general, a close-mesh screen structure that has many points of support is selected to ensure the stability of the screen material. A disadvantage is that the theoretical ink application volume, which is defined by the thickness of the mesh and the percentage of open area of the screen structure, is very limited. Thus, that technology has its limits, in particular if high lines of low width are to be printed as is the case, for example, in the manufacture of solar cells.

### SUMMARY OF THE INVENTION

It is accordingly an object of the invention to provide a method for manufacturing a screen structure and a screen structure for screen printing, which overcome the hereinafore-mentioned disadvantages of the heretofore-known methods and structures of this general type and in which the screen structure has a particularly high degree of stability. A further object is to provide a screen structure and a method for manufacturing such a screen structure wherein the screen structure has a greater ink application volume if used in screen printing.

With the foregoing and other objects in view there is provided, in accordance with the invention, a method for manufacturing a screen structure having at least two mesh layers, comprising the steps of providing a first mesh layer on a first reel and a second mesh layer on a second reel, bringing the first and second mesh layers together so that they contact each other, and jointly metalizing the first and second mesh layers with the applied metal firmly bonding the two mesh layers together to create a composite mesh.

The method of the invention is used to manufacture a screen structure that has at least two screen-like mesh layers. A first web-shaped mesh layer is provided on a first reel, and a second web-shaped mesh layer is provided on a second reel. In the context of the present invention, a mesh layer is understood to be a two-dimensional structure, including but not limited to a woven surface structure, perforated metal plates, non-woven webs, and electroformed stencils and films. In accordance with the invention, the first and second mesh layers are brought together, in particular by deflection rollers, in such a way that the first and second mesh layers contact each other. Advantageously, the first and second mesh layers are jointly metalized in such a way that the applied metal firmly bonds the two mesh layers to each other to create a composite mesh. A third mesh layer or further mesh layers may be bonded in the same way to create an even thicker composite mesh.

In accordance with another advantageous mode of the method of the invention, the composite mesh is then rinsed and dried and, if desired, if the screen structure is to be used for screen printing, a photosensitive layer or a locally removable polymeric layer is applied before the composite mesh is wound onto a third reel.

In accordance with a further advantageous mode of the method of the invention, in a first alternative, the metalizing that causes the two mesh layers to bond is a chemical metalizing process involving electroless metal deposition, i.e. so-called reductive metal deposition.

In accordance with an added particularly preferred mode of the method of the invention, in a second alternative, the metalizing that causes the two mesh layers to bond is an electrochemical electroplating process carried out, in particular, in a nickel bath.

As an alternative to the nickel bath, a copper bath or a tin bath may be used. The bath may contain a combination of various metals, e.g. nickel and silver.

With the objects of the invention in view, there is also provided a screen structure, in particular a screen structure suited for screen printing, comprising at least two screen-like mesh layers disposed to be substantially parallel to each other, the screen structure, in particular, being created in accordance with the process described above. In accordance with the invention, the mesh layers are provided with a metal layer applied in an electroplating process and the mesh layers are bonded to each other by this metal layer. In accordance with a preferred embodiment, the metal layer is mainly formed of nickel. Alternatively, other metals such as copper or tin may be used. A combination of various metals may be used, e.g. nickel and silver. An alternative field of use for the screen structure is filtration.

In accordance with another advantageous feature of the invention, a respective mesh layer is a steel mesh of thin wires. Such a steel mesh has a high degree of stability and firmness and is particularly easy to electroplate in an electrochemical process. Alternatively, a pre-treated synthetic mesh that has been made conductive, for example a polyester mesh, may be used. The respective mesh layers may be made of different mesh types. The mesh type is understood to be defined by the shape of the mesh, e.g. square mesh or longitudinal mesh, and the type of binding. The mesh type is to be selected as a function of the desired use of the screen structure.

With the objects of the invention in view, there is furthermore provided a method for manufacturing a screen structure that has at least two mesh layers, which comprises providing a first mesh layer on a first reel and a second mesh layer on a second reel and providing the first and/or second mesh layers with an emulsion for bonding the two mesh layers together. The first and second mesh layers are then brought together by deflection rollers to contact each other or to be spaced apart by only a small distance and to be bonded by the emulsion, resulting in a composite mesh. The emulsion may, in particular, be a photosensitive layer or a hot melt adhesive. The emulsion may easily be treated by laser.

With the objects of the invention in view, there is concomitantly provided a screen structure, in particular for screen printing, comprising at least two mesh layers disposed to be substantially parallel to each other and, in particular, manufactured in accordance with one of the methods described above, wherein in accordance with the invention the mesh layers are laminated to form a composite.

An advantage of the screen structures of the invention is that they have a high ink application volume, allowing a high printed line height to line width ratio. Another advantage is that the screen structures have a high degree of stability, ensuring in-register printing of fine lines and increasing the useful life of the screen structures.

Any combination of the invention described above and of the advantageous further developments of the invention above likewise represents an advantageous further development of the invention. The dependent claims and the description of exemplary embodiments with reference to the appended figures provide further advantages and embodiments of the invention that are advantageous in structural and functional terms.

Other features which are considered as characteristic for the invention are set forth in the appended claims.

Although the invention is illustrated and described herein as embodied in a method for manufacturing a screen structure and a screen structure for screen printing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side-elevational view illustrating a method of the invention for manufacturing a screen structure;

FIGS. 2A-2C are enlarged, fragmentary views illustrating various screen structures manufactured in accordance with the method;

FIG. 3A is a side-elevational view illustrating an alternative method for manufacturing a screen structure;

FIG. 3B is an enlarged, fragmentary view illustrating a screen structure manufactured in accordance with the method of FIG. 3A;

FIG. 4 is a perspective view of a prior art screen structure; and

FIG. 5 is a perspective view illustrating the use of the screen structure as a screen for rotary screen printing.

### DETAILED DESCRIPTION OF THE INVENTION

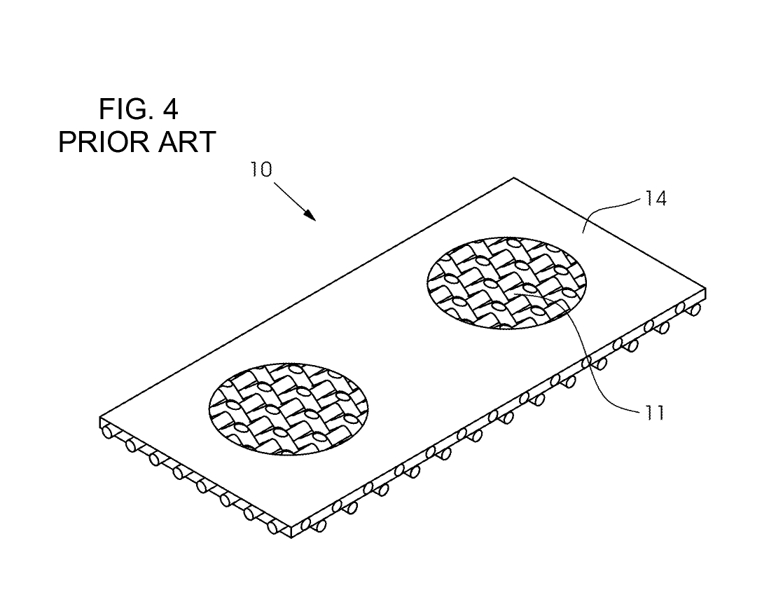

Referring now in detail to the figures of the drawings which are not drawn to scale but in which like elements and components are indicated by like reference symbols and first, particularly, to FIG. 4 thereof, there is seen a two-dimensional screen material 10 having one mesh layer 11 in accordance with the prior art. One side of the screen material 10 is provided with a photopolymer coating 14 (direct stencil). In a non-illustrated alternative embodiment, a film that has already been imaged may be applied to the screen structure 10 (indirect stencil). The nickel-plated two-dimensional screen material 10 is made of a one-piece mesh 11. Various mesh forms also referred to as mesh types may be used.

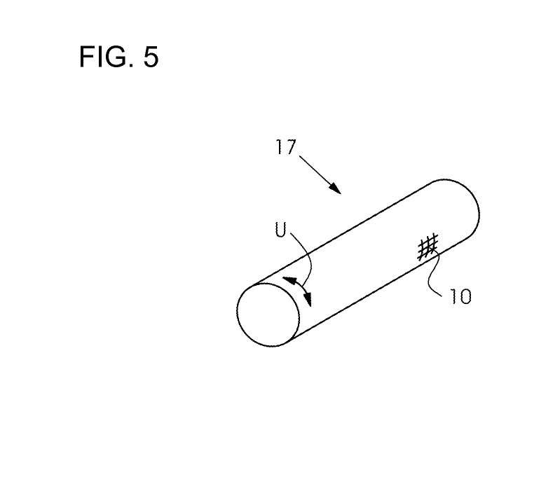

Such screen materials 10 are used in rotary screen printing. FIG. 5 illustrates a screen 17 with a two-dimensional screen material 10 in a cylindrical sleeve shape for rotary screen printing. The screen material 10 is held in its cylindrical shape by end pieces that will not be described in any detail herein. A non-illustrated doctor blade of a screen printing unit is disposed in the interior of the screen 17 for pressing ink through the screen material. The doctor blade may be aligned to be parallel to the axis of rotation of the screen 17. The circumferential direction U of the screen 17 in which the screen 17 rotates during printing, is indicated by a double-headed arrow.

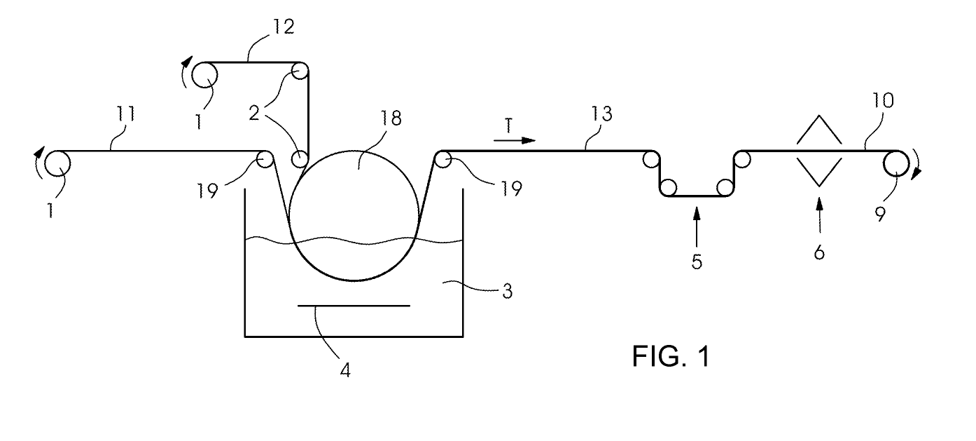

FIG. 1 illustrates a first method according to the invention for manufacturing a screen structure 10. A first mesh layer 11 is provided on a first supply reel 1. A second mesh layer 12 is provided on a second supply reel 1. The mesh layers 11, 12 may be pre-conditioned e.g. nickel-plated. The two mesh layers 11, 12 are brought together by deflection rollers 2 in a direction of transport T and in such a way that the first mesh layer 11 and the second mesh layer 12 contact each other. Contact needs to be established in the region of a dipping roller 18 at the latest. The two mesh layers 11, 12 are passed around the dipping roller 18 and a cathode 19 and through an electroplating bath 3, for instance a nickel bath with an anode 4 to be electroplated in an electrochemical process. If a nickel bath 3 is used, the first mesh layer 11 and the second mesh layer 12 are nickel-plated in such a way that both mesh layers 11, 12 are firmly bonded to each other to form a composite mesh 13. The composite mesh 13 may be washed in a downstream washing unit 5 and dried in a downstream drying unit 6 before it is wound onto a wind-up reel 9. Although only one electroplating bath 3 is shown in FIG. 1, the electroplating process may be carried out in a number of successive steps, for example using a number of electroplating baths 3.

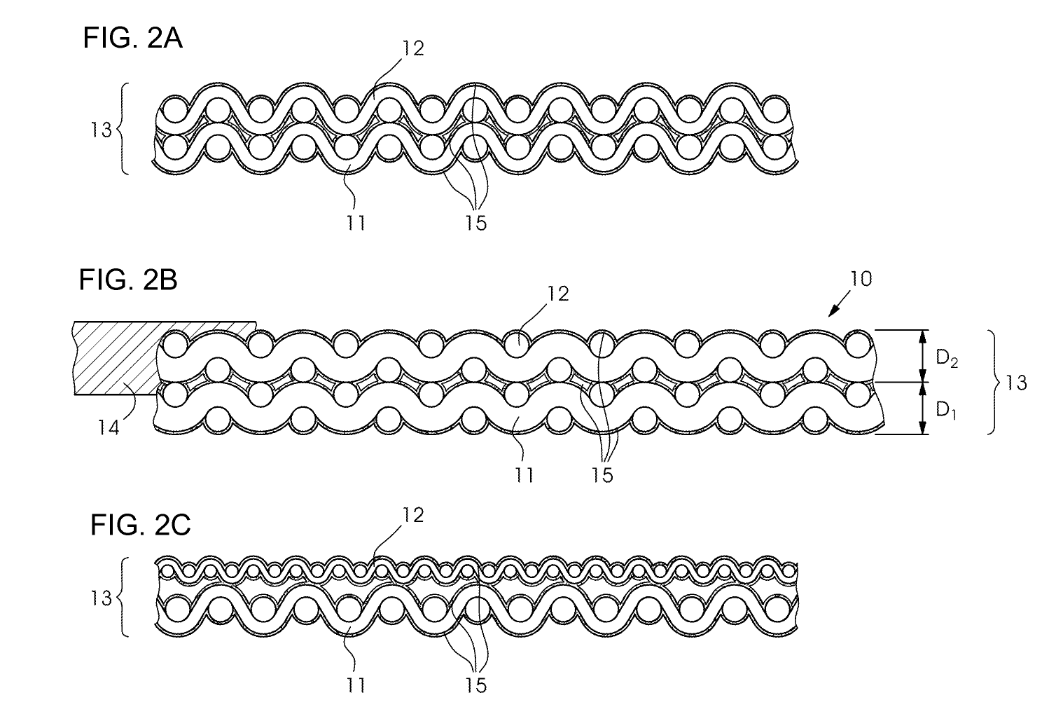

FIGS. 2A, 2B and 2C illustrate various screen structures 10 that have been manufactured in accordance with this process. The screen structure 10 may include a photosensitive layer 14 allowing the screen structure 10 to be used in screen printing. The screen structure has a composite mesh 13 composed of a first mesh layer 11 and a second mesh layer 12. The first mesh layer 11 and the second mesh layer 12 are bonded to each other by a metal layer 15. The top side of the first mesh layer 11 and the underside of the second mesh layer 12 are also coated with a metal layer 15. The metal layer 15 may be a nickel layer, for instance, that has been applied by nickel-plating in an electroplating nickel bath. As is seen in FIG. 2B, the thickness of the composite mesh 13 is composed of a thickness D1 of the first mesh layer 11 and a thickness D2 of the second mesh layer 12. Twice the thickness of the applied metal layer 15 also contributes to the total thickness. It is apparent that due to the increased thickness D1+D2 of the composite mesh 13 as compared to the thickness D1 of the first mesh layer and D2 of the second mesh layer, a screen structure of greater stability has been created. If the screen structure 10 is used in a screen printing process, this feature provides an increased ink application volume, since the latter is directly dependent on the thickness D1+D2 of the screen structure 10. FIG. 2C illustrates a screen structure 10 formed of two different mesh layers 11 and 12.

In a non-illustrated alternative embodiment, the first mesh layer 11 and the second mesh layer 12 may be separately provided with a metal layer 15 in advance in a previous step. The mesh layers 11, 12 that have been metalized in this way may then be bonded to each other in the manner described above by an additional metal layer 15. In other words, the respective mesh layers are electroplated in a first step as is known in the art. Subsequently, the electroplated mesh layers are bonded to each other in accordance with the invention.

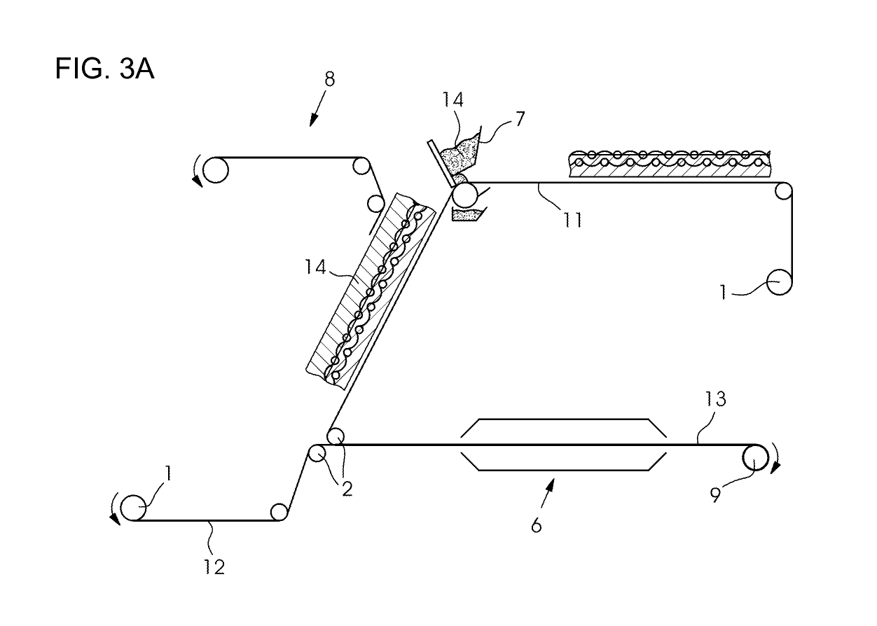

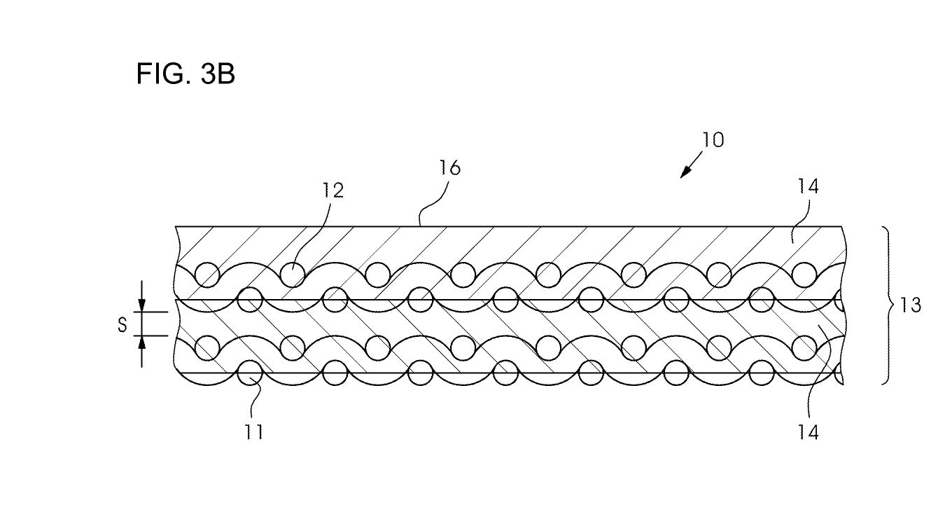

FIG. 3A illustrates an alternative method for manufacturing a screen structure 10. A first mesh layer 11, which may be uncoated or pre-coated, is provided on a first supply reel 1. A second mesh layer 12 is provided on a second supply reel 1. An emulsion 14 is applied to the first mesh layer 11 in a first application unit 7. Subsequently, a capillary film may be applied to the emulsion layer 14 in a device 8. The first mesh layer 11 that has been pre-treated in this way is then brought together with the second mesh layer 12 by deflection rollers 2 and both mesh layers 11, 12 are pressed together to form a composite mesh 13. In order to ensure stable bonding between the two mesh layers 11, 12, the emulsion is dried in a drying unit 6 before the composite mesh 13 is wound onto a wind-up reel 9. FIG. 3B illustrates a screen structure 10 manufactured in accordance with this process. A first mesh layer 11 and a second mesh layer 12 are laminated by two emulsion layers 14 to form a composite mesh 13. A spacing S between the two mesh layers 11, 12 may be varied to vary the thickness of the composite mesh 13. One side of the composite mesh 13 may additionally be provided with a carrier foil 16.

1. A method for manufacturing a screen structure having at least two mesh layers, the method comprising the following steps:
providing a first mesh layer on a first reel and a second mesh layer on a second reel;
bringing the first and second mesh layers together and into contact with each other; and
jointly metalizing the first and second mesh layers and firmly bonding the first and second mesh layers together with applied metal to create a composite mesh.

2. The method for manufacturing a screen structure according to claim 1, which further comprises subsequently rinsing and drying the composite mesh.

3. The method for manufacturing a screen structure according to claim 1, which further comprises applying a photosensitive layer or a locally removable polymeric layer before winding the composite mesh onto a third reel.

4. The method for manufacturing a screen structure according to claim 1, which further comprises carrying out the metalizing step as a chemical metalizing process involving electroless metal deposition.

5. The method for manufacturing a screen structure according to claim 1, which further comprises carrying out the metalizing step as an electrochemical electroplating process.

6. The method for manufacturing a screen structure according to claim 5, which further comprises carrying out the electrochemical electroplating process in a nickel bath.

7. A screen structure, comprising:
at least two mesh layers being substantially parallel to each other; and
an electroplated metal layer bonding said at least two mesh layers to each other.

8. The screen structure according to claim 7, wherein said at least two mesh layers include first and second mesh layers contacting each other and being jointly metalized and firmly bonded with metal to create a composite mesh.

9. The screen structure according to claim 7, wherein the screen structure is a screen printing structure.

10. The screen structure according to claim 7, wherein said metal layer is substantially formed of nickel.

11. The screen structure according to claim 7, wherein said at least two mesh layers are respective steel mesh layers.

12. The screen structure according to claim 7, wherein said at least two mesh layers are formed of different mesh types.

13. A method for manufacturing a screen structure having at least two mesh layers, the method comprising the following steps:
providing a first mesh layer on a first reel and a second mesh layer on a second reel;
applying an emulsion to at least one of the first or second mesh layers for bonding the two mesh layers;
bringing the first and second mesh layers together using deflection rollers; and
bonding the first and second mesh layers using the emulsion to form a composite mesh.

14. The method according to claim 13, which further comprises providing a photosensitive layer as the emulsion.

15. A screen structure, comprising:
at least two mesh layers disposed substantially parallel to each other;
said mesh layers being laminated to form a composite.

16. The screen structure according to claim 15, wherein the screen structure is a screen printing structure.

17. The screen structure according to claim 15, wherein said at least two mesh layers include first and second mesh layers, and an emulsion is applied to at least one of the first or second mesh layers and bonds the first and second mesh layers together to form a composite mesh.
